(19) United States
(12) Patent Application Publication
(10) Pub. No.: US 2013/0064493 A1
(43) Pub. Date: Mar. 14, 2013

(54) MULTI-FIBER POLARIZATION SCRAMBLER/CONTROLLER

(71) Applicants: Michael Minneman, Lafayette, CO (US); Michael Crawford, Lafayette, CO (US)

(72) Inventors: Michael Minneman, Lafayette, CO (US); Michael Crawford, Lafayette, CO (US)

(73) Assignee: dBm Optics, Inc., Lafayette, CO (US)

(21) Appl. No.: 13/555,110

(22) Filed: Jul. 21, 2012

Related U.S. Application Data
(60) Provisional application No. 61/510,759, filed on Jul. 22, 2011.

(51) Int. Cl. G02B 6/00

(52) U.S. Cl. 385/11

(57) ABSTRACT

A system and method for applying polarization scrambling through a device to a plurality of fiber optic cables by applying a compressive load simultaneously to each of the plurality of fiber optic cables in order to scramble polarization to each of the plurality of fiber optic cables simultaneously.

### RELATED APPLICATION DATA

This application claims the benefit of U.S. Provisional Application No. 61/510,759, filed Jul. 22, 2011, which is hereby incorporated in by reference.

### TECHNICAL FIELD

The present invention relates generally to a system and method to control or scramble the polarization state of a plurality of fibers simultaneously.

### BACKGROUND

It is common in photonic measurement systems for applications to desire scrambling of the polarization state of light in a fiber to allow measurement of polarization-independent insertion loss. By changing the polarization state of the light at a rate that is substantially faster than the measurement time of the magnitude of the light, the measurement of amount of light is unaffected by the polarization state of that light.

In other applications, the polarization dependency of insertion loss can be ascertained by changing the polarization state of the light at a rate slow enough so that the magnitude of the light at different polarization states can be measured; the difference between the maximum and minimum insertion loss is by definition the polarization dependent loss (PDL). The difference between these two applications is the rate of change of the polarization state relative to the speed of the measurement.

Conventional polarization controllers have focused on adjusting single optical fibers to manipulate the polarization state of the light in the fibers.

### SUMMARY

Aspects of the present invention overcome the above identified problems by adjusting multiple optical fibers simultaneously to manipulate the polarization state of the light in the fibers. For example, if a device being tested has multiple outputs, and if those outputs are then routed through an optical switch, which routes one (or more) of these fibers to a measurement system sequentially, any PDL of the switch will deleteriously effect the ability to discern the PDL of the device separate from the PDL of the switch. If, after the device, the polarization state of all light in all the fibers could be scrambled at low cost, it could substantially reduce the uncertainty of the overall measurement.

For example, if a device being tested has multiple outputs, and if those outputs are then routed through an optical switch, which routes one (or more) of these fiber optic cables to a measurement system sequentially, any PDL of the switch will deleteriously effect the ability to discern the PDL of the device separate from the PDL of the switch. If, after the device, the polarization state of all light in all the fibers could be scrambled at low cost, it could substantially reduce the uncertainty of the overall measurement.

One aspect of the invention relates to a system including: a device configured to receive a compressive force and to hold a plurality of fiber optic cables; a loading device configured to apply a load on the device; a polarization controller configured to control the applied load on the device in order to scramble polarization to each of the plurality of fiber optic cables simultaneously.

Another aspect of the invention relates to a method for polarizing a plurality of fiber optic cables simultaneously, the device including: providing a plurality of fiber optic cables between a first member and a second member, wherein a plurality of intersections are formed between the first member and the second member and each of the plurality of intersections are configured to receive one of the plurality of fiber optic cables; outputting light from a laser into a first end of each of the plurality of fiber optic cables; detecting light output by the laser at a detector and generating at least one output signal; and processing the at least one output signal and controlling a loading device to apply a load to at least one of the first member or the second member in order to scramble polarization to each of the plurality of fiber optic cables simultaneously.

Another aspect of the invention relates to a polarization dependent loss measurement system, the system including: a laser source, a detector to detect light output from the laser source; a polarization controller including a plurality of structures configured to receive a compressive and/or a tensile force and the polarization controller further configured to hold a plurality of fiber optic cables and a loading device configured to apply a load on at least a portion of the plurality of structures to adjust polarization of the plurality of fiber optic cables; and a processor coupled to the detector and the polarization controller, wherein the processor is configured to receive one or signals output by the detector and provide a feedback control signal to the polarization controller.

A number of features are described herein with respect to embodiments of the invention. It will be appreciated that features described with respect to a given embodiment also may be employed in connection with other embodiments.

The invention comprises the features described herein, including the description, the annexed drawings, and the claims, which set forth in detail certain illustrative embodiments. These embodiments are indicative, however, of but a few of the various ways in which the principles of the invention may be employed.

### BRIEF DESCRIPTION OF THE DRAWINGS

In the annexed drawings:

FIGS. 1-3 are schematic views of an exemplary device in accordance with aspects of the present invention.

FIG. 4 is an exemplary system in accordance with aspects of the present invention.

FIGS. 5-6 are exemplary illustrations of a prior art device.

FIG. 7 is an exemplary method in accordance with aspects of the present invention.

### DESCRIPTION

U.S. Pat. No. 6,493,474, which is incorporated herein by reference, discloses a method of in-line fiber optic cable scrambling using a series of three or four piezoelectric-type transducers that apply pressure to the fiber optic cable along different axes transverse to the fiber core, which results a change in the polarization state within the fiber optic cable.

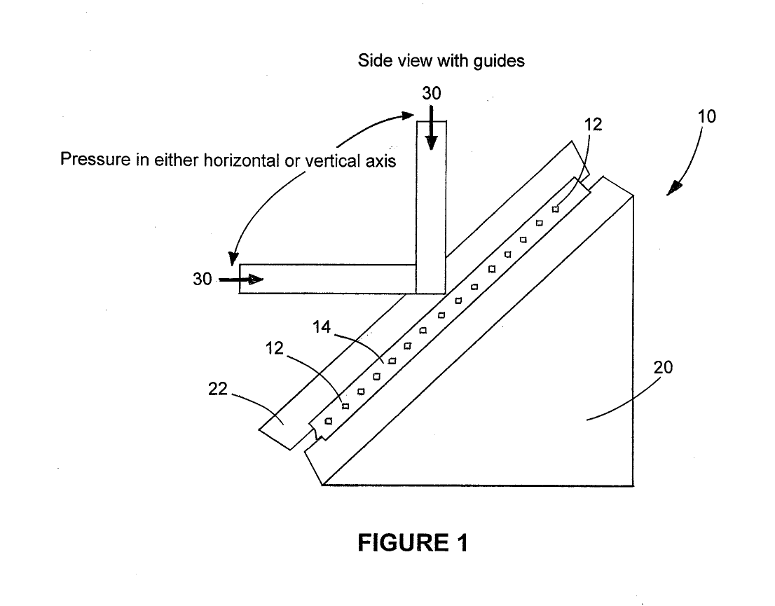

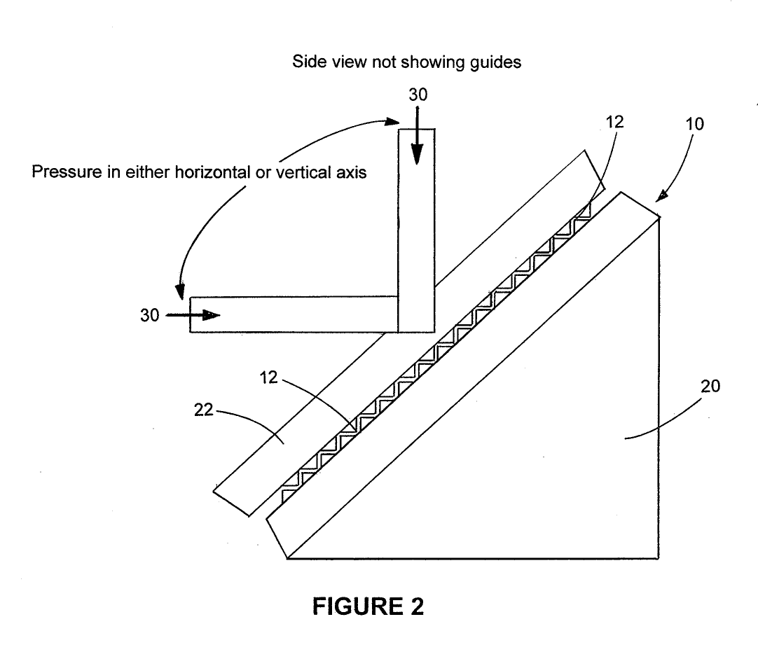

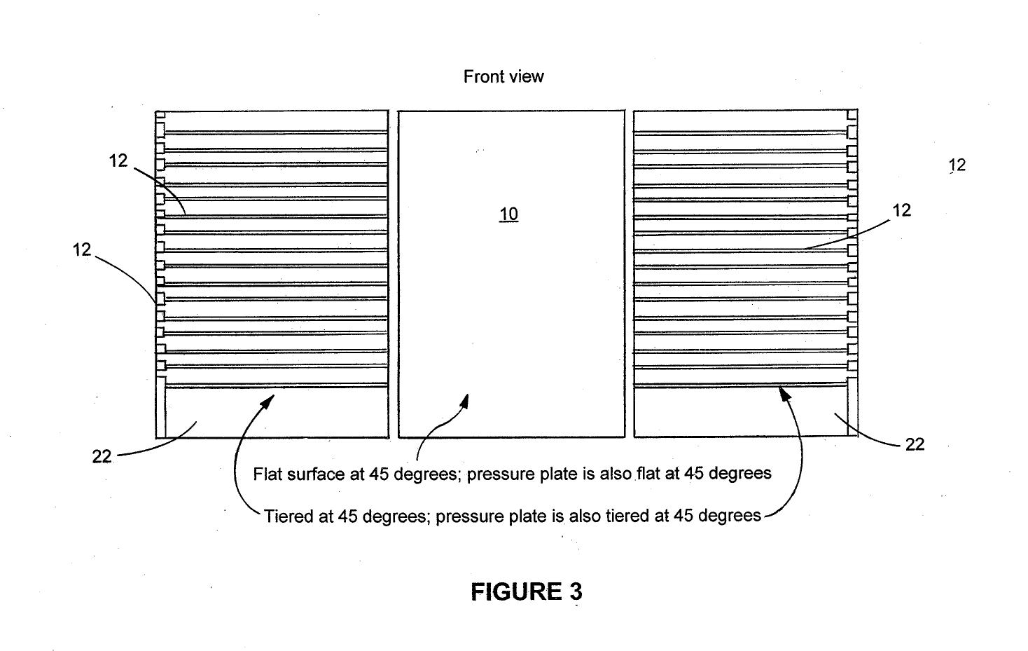

FIG. 1 illustrates an exemplary device 10 that is configured for applying polarization scrambling to a plurality of fiber optic cables simultaneously. Referring to FIG. 1, the device 10 is configured to receive or accept a plurality of fiber optic cables at one or more receptacles 12 formed in one or more guides 14. The device 10 illustrated in FIG. 1 shows sixteen receptacles 12 configured to receive sixteen fiber optic cables. FIG. 2 shows the side view of the device 10 with the fiber guide 14 cut away. FIG. 3 illustrates a front view of the device 10.

As shown in FIGS. 1-3, there are three segments of the device 10. In one embodiment, the first and third segments, the fiber optic cables rest in a tiered mechanical structure (e.g., a stepped structure), one tier for each fiber, as illustrated in FIG. 2). The receptacles 12 may be formed at an interface between the components that form the device 10. Pressure may then applied from the top or side in these first and third segments, as illustrated in FIGS. 1 and 2. In the middle or second segment, a 45 degree structure is illustrated, which allows the pressure from the second transducer to be applied at a prescribed angle (e.g., 45 degrees) across all of the fiber optic cables.

One of ordinary skill will appreciate that the angles and mechanical structures noted above are exemplary in nature and not intended to limit the scope of the present invention. Any angle or structure may be used in accordance with aspects of the present invention.

The device 10 may include two sections 20, 22 that are configured to receive the plurality of fiber optic cables and guide 14. The section 20 may be a stationary base and the section 22 may be configured to receive a compressive load from a loading device 30 and apply such a load through the plurality of fiber optic cables to the base section 20.

When the device 10 applies pressure to the plurality of fiber optic cables through the sections 20, 22, linear birefringence is induced in each of the fiber optic cables. The slow axis of the birefringence is oriented in the direction of the applied pressure and typically increases linearly with the applied force. The pressure-induced birefringence can vary from 0 to π/2, for example. The applied force also changes the optical path length and induces a phase change in the light propagating in each of the fibers. More specifically, the retardation of light with a polarization oriented along the slow axis of the birefringence may be retarded from 0 to 2π with respect to light with a polarization oriented perpendicular to the slow axis.

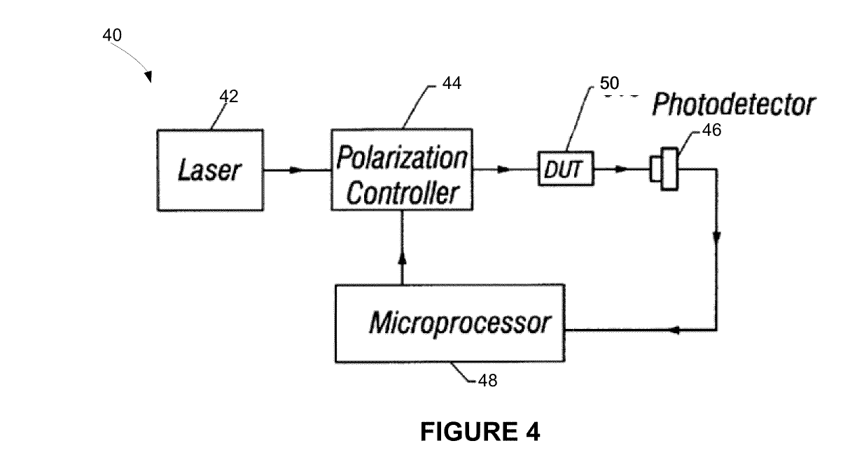

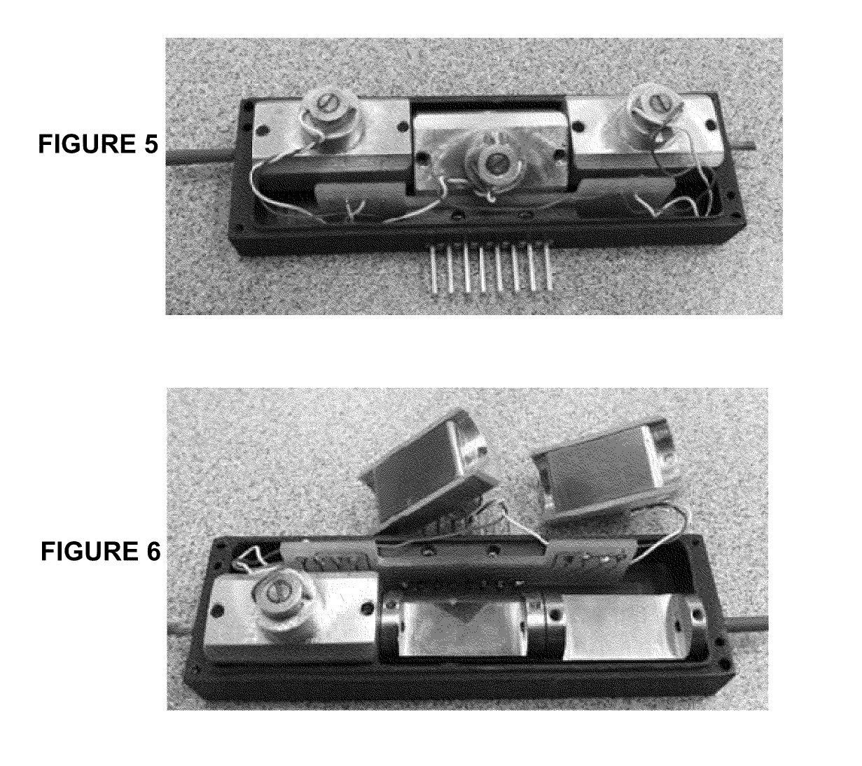

By adjusting the amount of load applied to the sections 20, 22, the polarization of the light propagating in each of fiber optic cables can be rotated along a Poincare sphere. A suitable control system (FIG. 4) may monitor the polarization input to and output by a polarization controller to regulate the amount of pressure applied to device 10.

FIG. 4 illustrates an exemplary system 40 in accordance with aspects of the present invention. A particularly suitable application for the described device 10 is in polarization dependent loss (PDL) measurement equipment. The PDL of an optical component is defined as the difference between the maximum and the minimum insertion losses for all possible input states of polarization (SOP). FIG. 4 illustrates a PDL meter that includes a laser source 42, a polarization controller 44, one or more photodetectors 46, and a microprocessor or a control circuit 48. A device under test (DUT) 50 is inserted between polarization controller 44 and the one or more photodetectors 46. In a first measurement, control circuit 48 adjusts polarization controller 44 to minimize light loss in DUT 50 and thus maximize the optical power reaching the one or more photodetectors 46. In a second measurement, microprocessor 48 adjusts polarization controller 44 to maximize light loss in DUT 50 and thus minimize power reaching the one or more photodetectors 46. The PDL of DUT 50 can be calculated as:

PDL=10 log(first measurement/second measurement)

The microprocessor 48 is may be controlled through software to program control circuit 48 to apply a desired load to one or more actuators and/or other force inducing member to impart the desired load to the device. The processor 48 may also be controlled by software to receive output data from the photodetector 46. The data detected at the photodetector 46 may be processed by the microprocessor 48 to determine optical power, detect birefringence in the fiber optic cables and/or used as feedback by the polarization controller 44 to adjust polarization of the one or more fiber optic cables.

Various mechanisms may be used to control the pressure applied by the loading device 30 to the fiber optic cables. For example, a spring that maintains a constant force, a piezoelectric transducer or other such device may be used. Preferably, the control circuit 48 is operative to control an amount of force applied to the fiber optic cables and a time frame in which to apply the force to the fiber optic cables.

One of ordinary skill in the art will appreciate that there are other mechanical structures that can achieve the same result of simultaneous polarization state scrambling. Likewise, there are other transducers that may be used to cause the polarization state change within the fiber optic cables.

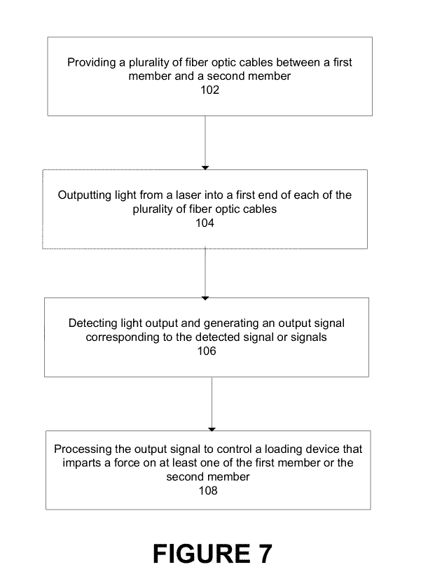

An exemplary method 100 for polarizing a plurality of fiber optic cables simultaneously in accordance with aspects of the present invention is illustrated in FIG. 7. At block 102, the method includes providing a plurality of fiber optic cables between a first member and a second member, wherein a plurality of intersections are formed between the first member and the second member and each of the plurality of intersections are configured to receive one of the plurality of fiber optic cables.

At block 104, light is output light from a laser into a first end of each of the plurality of fiber optic cables.

At block 106, light output by the laser is detected at a detector and the detector generates at least one output signal corresponding to the detected signal or signals. In one embodiment, a plurality of output signals are generated for each of the plurality of fiber optic cables.

At block 108, the at least one output signal is processed to control a loading device, wherein the loading device applies a load to at least one of the first member or the second member in order to scramble polarization to each of the plurality of fiber optic cables simultaneously. In one embodiment, the loading device includes a first loading member configured to apply a load to the plurality of fiber optic cables in a first direction and a second loading member configured to apply a load to the plurality of fiber optic cables in a second direction, wherein the first direction and the second direction are non-parallel. The first and second directions are generally anti-parallel. In one embodiment, the first direction is normal to the second direction. In another embodiment, a single loading member is configured to apply a load to the plurality of fiber optic cables.

The load applied to the plurality of fiber optic cables induces linear birefringence in each of the plurality of fiber optic cables. Therefore, by controlling an amount of force applied by the loading device, the polarization of the light propagating in each of the plurality of fiber optic cables may be rotated along a Poincare sphere.

As described above, a device under test may inserted between the laser and the detector, wherein the loading device is controlled to adjust polarization to maximize optical power reaching at least one of the detectors and minimizing optical power reaching at least one of the detectors and minimizing optical power reaching at least one of the detectors, which enables PDL associated with the DUT.

Although the invention is shown and described with respect to illustrative embodiments, it is evident that equivalents and modifications will occur to those persons skilled in the art upon the reading and understanding hereof. The present invention includes all such equivalents and modifications and is limited only by the scope of the claims if appended hereto.

What is claimed is:

1. A system comprising:
a device configured to receive a compressive force and to hold a plurality of fiber optic cables;
a loading device configured to apply a load on the device;
a polarization controller configured to control the applied load on the device in order to scramble polarization to each of the plurality of fiber optic cables simultaneously.

2. The system of claim 1, wherein the loading device is a piezoelectric device.

3. The system of claim 2, the applied load is a compressive load.

4. The system of claim 1, wherein the device includes a first section and second section, wherein each of the first section and the second section are configured to form a plurality of ports to receive the plurality of fiber optic cables at an intersection between the first section and the second section.

5. The system of claim 4, wherein the first section and the second section are in a stepped arrangement.

6. The system of claim 1, wherein the loading mechanism is applied at a common angle for each of the plurality of fiber optic cables.

7. A method for polarizing a plurality of fiber optic cables simultaneously, the device comprising:
providing a plurality of fiber optic cables between a first member and a second member, wherein a plurality of intersections are formed between the first member and the second member and each of the plurality of intersections are configured to receive one of the plurality of fiber optic cables;
outputting light from a laser into a first end of each of the plurality of fiber optic cables;
detecting light output by the laser at a detector and generating at least one output signal;
processing the at least one output signal and controlling a loading device to apply a load to at least one of the first member or the second member in order to scramble polarization to each of the plurality of fiber optic cables simultaneously.

8. The method of claim 7, wherein a plurality of output signals are generated for each of the plurality of fiber optic cables.

9. The method of claim 7, wherein the first member and the second member intersect at a prescribed angle.

10. The method of claim 9, wherein the prescribed angle is common for each of the plurality of fiber optic cables.

11. The method of claim 7, wherein the loading device is a piezoelectric device.

12. The method of claim 7, wherein the loading device includes a first loading member configured to apply a load to the plurality of fiber optic cables in a first direction and a second loading member configured to apply a load to the plurality of fiber optic cables in a second direction, wherein the first direction and the second direction are non-parallel.

13. The method of claim 12, wherein the first direction is normal to the second direction.

14. The method of claim 13, wherein the load applied to the plurality of fiber optic cables causes linear birefringence in each of the plurality of fiber optic cables.

15. The method of claim 7, wherein by controlling an amount of force applied by the loading device, the polarization of the light propagating in each of the plurality of fiber optic cables may be rotated along a Poincare sphere.

16. The method of claim 7, wherein a device under test is inserted between the laser and the detector, wherein the loading device is controlled to adjust polarization to maximize optical power reaching at least one of the detectors.

17. The method of claim 7, wherein a device under test is inserted between the laser and the detector, wherein the loading device is controlled to adjust polarization to minimize optical power reaching at least one of the detectors.

16. A polarization dependent loss measurement system, the system comprising:
a laser source,
a detector to detect light output from the laser source;
a polarization controller including a plurality of structures configured to receive a compressive and/or a tensile force and the polarization controller further configured to hold a plurality of fiber optic cables and a loading device configured to apply a load on at least a portion of the plurality of structures to adjust polarization of the plurality of fiber optic cables; and
a processor coupled to the detector and the polarization controller, wherein the processor is configured to receive one or signals output by the detector and provide a feedback control signal to the polarization controller.
